(19) United States
(12) Patent Application Publication
(10) Pub. No.: US 2010/0169908 A1
(43) Pub. Date: Jul. 1, 2010

(54) METHODS AND APPARATUS TO ENFORCE A POWER OFF STATE OF AN AUDIENCE MEASUREMENT DEVICE DURING SHIPPING

(76) Inventor: Christen V. Nielsen, Palm Harbor, FL (US)

Correspondence Address: Hanley, Flight & Zimmerman, LLC, 150 S. Wacker Dr. Suite 2100, Chicago, IL, 60606, US

(21) Appl. No.: 12/346,423

(22) Filed: Dec. 30, 2008

(51) Int. Cl. H04H 60/32

(52) U.S. Cl. 725/14

(57) ABSTRACT

Methods and apparatus to enforce a power off state of an audience measurement device during shipping of the device are disclosed herein. An example portable audience measurement device includes a housing, a media detector in the housing to collect media exposure data and a packaging sensor to detect an environmental condition exterior to the device. A packaging detector compares the detected environmental condition to a criterion to determine whether the device is located within the package.

### CROSS REFERENCE TO RELATED APPLICATIONS

This application is related to U.S. patent application Ser. No. 12/346,416 entitled “Methods and Apparatus to Enforce a Power Off State of an Audience Measurement Device During Shipping,” filed concurrently herewith under Attorney Docket No. 20004/405-US, and U.S. patent application Ser. No. 12/346,430 entitled “Methods and Apparatus to Enforce a Power Off State of an Audience Measurement Device During Shipping,” filed concurrently herewith under Attorney Docket No. 20004/417-US, the contents of which are incorporated herein by reference in their entirety.

### FIELD OF THE DISCLOSURE

The present disclosure relates generally to audience measurement and, more particularly, to methods and apparatus to enforce a power off state of an audience measurement device during shipping of the device.

### BACKGROUND

Media-centric companies are often interested in tracking the number of times that audience members are exposed to media compositions (e.g., television programs, motion pictures, internet videos, radio programs, etc.). In some instances, to track such exposures, companies generate audio and/or video signatures of media compositions (e.g., a representation of some, preferably unique, portion of the media composition or the signal used to transport the media composition) that can be used to determine when those media compositions are presented to audience members. The media compositions may be identified by comparing the signature to a database of reference signatures. Additionally or alternatively, companies transmit identification codes (e.g., watermarks) with media compositions to facilitate monitoring presentations of those media compositions to audience members by comparing identification codes retrieved from media compositions presented to audience members with reference identification codes stored in a reference database. Like the reference signature, the reference codes are stored in association with information descriptive of the corresponding media compositions to enable identification of the media compositions.

Media ratings and other metering information are typically generated by collecting media exposure information from a group of statistically selected households. Each of the statistically selected households typically has a data logging and processing unit such as, for example, a stationary or portable media measurement device, commonly referred to as a “metering device” or “meter.” The meter typically includes sensors to gather data from the monitored media presentation devices (e.g., audio-video (AV) devices) at the selected site. The meters also deliver the gathered data to a centralized location for processing.

### BRIEF DESCRIPTION OF THE DRAWINGS

FIG. 1 is a block diagram of an example media exposure measurement system.

FIG. 2 is a block diagram of the example metering device of FIG. 1.

FIGS. 3A-3E illustrate example implementations of the example metering device of FIG. 2 located in an example package.

FIGS. 4A-4C are flow diagrams representative of example machine readable instructions that may be executed to implement the example metering devices of FIG. 2 and FIGS. 3A-3E, to collect media exposure information, and to determine whether the metering device is located within a package.

FIG. 5 is a block diagram of an example processor system that may be used to execute the machine readable instructions of FIG. 4 to implement the example metering device of FIG. 2.

### DETAILED DESCRIPTION

Although the following discloses example methods, apparatus, systems, and articles of manufacture including, among other components, firmware and/or software executed on hardware, it should be noted that such methods, apparatus, systems, and articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The example methods, apparatus, systems, and articles of manufacture described herein can be used to power on and/or power off a metering device such as, for example, a stationary or a portable media measurement device. To collect media exposure information, the metering device is configured to generate, detect, decode, and/or, more generally, collect media identifying data (e.g., audio codes, video codes, audio signatures, video signatures, or tuning information, etc.) associated with media presentations to which the portable meter is exposed.

The media exposure data is collected by the meter and forwarded to a central facility where it is used to statistically determine the size and/or demographics of audiences exposed to media presentations. The process of enlisting and retaining the panel participants (“panelists”) can be a difficult and costly aspect of the audience measurement process. For example, panelists must be carefully selected and screened for particular demographic characteristics so that the panel is representative of the population(s) of interest. In addition, installing traditional audience measurement devices in panelist's residences has been expensive and time consuming. Thus, it is advantageous to create a meter that is less costly and can be installed easily by a panelist to make participation easier.

In the example meter described herein, a mailable metering device collects audio codes and/or signatures and stores them into memory for the limited time frame the meter is in the panelist's home. The meter is assembled and activated at a first location, and is mailed to the panelist who installs the meter by, for example, placing it near a media presentation device (e.g., a television) to be monitored. The meter (preferably wirelessly) collects data regarding the media presentations exposed to the meter for a time frame (e.g., one month). Once the time frame expires, the meter is placed into return packaging by the panelist and mailed to a collection center (e.g., a central facility) for data extraction. The example metering device is active (e.g., is at least partially powered “on”) at the time of configuration (pre-shipping) and is in a stand-by mode or powered off during shipping. An internal clock or other mechanism initiates a “wake-up” at a specific time to begin metering (e.g., to collect data regarding media exposure). At the end of the metering period (e.g., when the memory is full, the time period expires, etc.), the device generates a “mail me back” reminder. The meter goes back into the stand-by or powered off mode when packaged for mailing to the central facility and remains in that mode until the data is extracted at the central facility.

Some mail carriers, however, do not allow items to be shipped with batteries installed therein. This prohibition against battery usage during shipment eliminates the ability to ship a metering device that is at least partially powered on. Other carriers allow a device to be shipped with batteries installed as long as the batteries are installed inside the device, and the device is powered “off.” These carriers define “off” as all circuits being inactive except for real-time clocks and memory keep-alive circuits. To address this problem, the meters disclosed herein automatically power on or power down by detecting a stimulus and determining when the meter is located in or out of a shipping container.

The example methods, apparatus, systems, and articles of manufacture described herein determine whether the metering device is located within a mailer, or other shipping container, by sensing particular environmental factors and determining whether the sensed factors are indicative of the metering device being located within the package. In particular, in some examples, the metering device includes a light sensor to sense the amount of ambient light that is present in the environment surrounding the metering device. In other examples, the metering device includes at least one sensor to detect the distance between the meter and the surrounding walls and/or to detect the volume of space surrounding the meter. In still other examples, the metering device includes at least one radio frequency (RF) field disturbance sensor to detect an RF field surrounding the metering device. The metering device determines whether or not it is located within a mailer based on whether or not the sensed environmental factors indicate that the meter is within the package. For example, if the sensed environmental factor is a light reading, then a sufficiently “dark” light reading will indicate that the meter is within the mailer. In other examples, if the measured environmental factor is a distance reading and/or volume reading, a value less than a threshold (e.g., a minimum distance and/or volume threshold) will be indicative of the meter being within the package. In still other example, if the measured environmental factor is an RF field disturbance, a reading value greater than a threshold (e.g., a maximum field disturbance allowance) will be indicative of the meter being within the package. The determined meter location can be used to power off the device when the device is determined to be within the mailer, thereby ensuring compliance with the regulations of shipping and/or courier services.

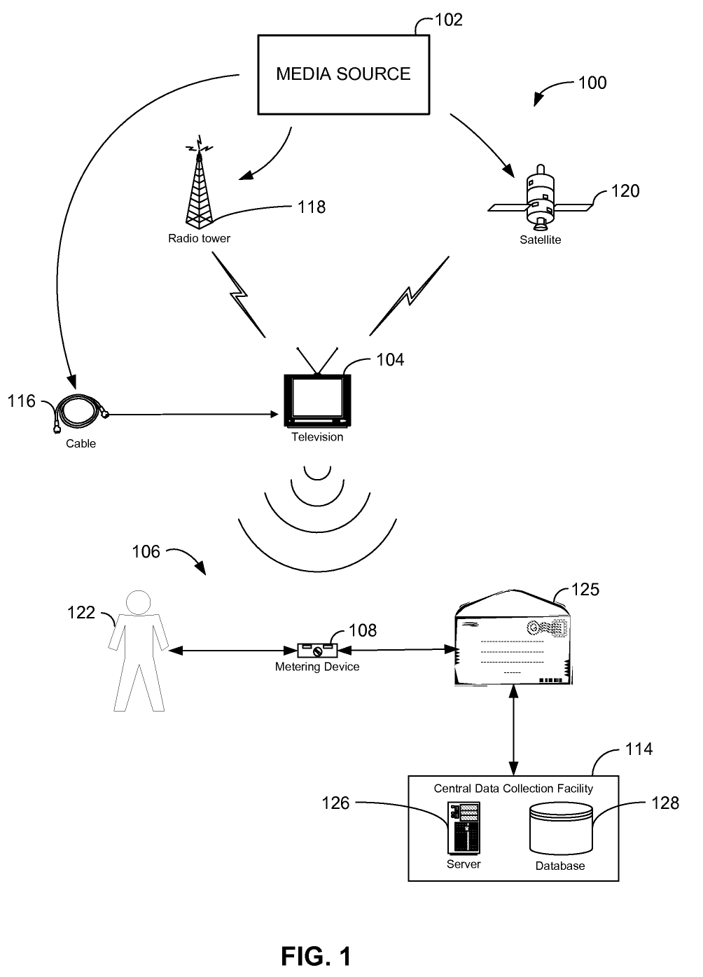

In the example of FIG. 1, an example media presentation system 100 including a media source 102 and a media presentation device 104 is metered using an example media measurement system 106. The example media measurement system 106 includes a “mailable” metering device 108 and a central facility 114. The metering device 108 is “mailable” in the sense that its size (e.g., form factor) enables it to be shipped via a commercial carrier such as, for example, the United States Postal Service (“USPS”), United Parcel Service (“UPS”), FedEx, DHL, and/or other suitable postal service. The media presentation device 104 is configured to receive media from the media source 102 via any of a plurality of transmission systems including, for example, a cable service provider 116, a radio frequency (RF) service provider 118, a satellite service provider 120, an Internet service provider (ISP) (not shown), or via any other analog and/or digital broadcast network, multicast network, and/or unicast network. Further, although the example media presentation device 104 of FIG. 1 is shown as a television, the example media measurement system 106 is capable of collecting information from any type of media presentation device including, for example, a personal computer, a laptop computer, a radio, a cinematic projector, an MP3 player, or any other audio and/or video presentation device or system.

The metering device 108 of the illustrated example is disposed on or near the media presentation device 104 and may perform one or more of a plurality of metering methods (e.g., channel detection, collecting signatures and/or codes, etc.) to collect data concerning the media exposure of the metering device 108, and thus, the media exposure of one or more panelist(s) 122. Depending on the type(s) of metering that the metering device 108 performs, the metering device 108 may be physically coupled to the presentation device 104 or may instead be configured to capture signals emitted externally by the presentation device 104 such that direct physical coupling to the presentation device 104 is not required. For instance, in this example, the metering device 108 is not physically or electronically coupled to the monitored presentation device 104. Instead, the metering device 108 is provided with at least one audio sensor, such as, for example, a microphone, to capture audio data regarding in-home media exposure for the panelist 122 and/or a group of household members. Similarly, the example metering device 108 is configured to perform one or more of a plurality of metering methods (e.g., collecting signatures and/or codes) on the collected audio to enable identification of the media to which the panelist(s) 122 carrying and/or proximate to the device 108 are exposed.

In the example of FIG. 1, the metering device 108 is adapted to be mailed to and/or from the remotely located central data collection facility 114 within a shipping container 125 such as, for example, an envelope, package, or other mailer, via a package delivery service. The example central data collection facility 114 includes a server 126 and a database 128 to process and/or store data received from the metering device 108 and/or other metering device(s) (not shown) used to measure other panelists. In another example, multiple servers and/or databases may be employed as desired. The package delivery service may be any suitable package delivery service including, for example, the United States Postal Service (“USPS”), United Parcel Service (“UPS”), FedEx, DHL, etc. It will be appreciated that the shipping address of the facility that receives the meter 108 may be separately located from the central data collection facility 114, and that the central data collection facility 114 may be communicatively coupled to the meter collection facility via any suitable data transfer network and/or method.

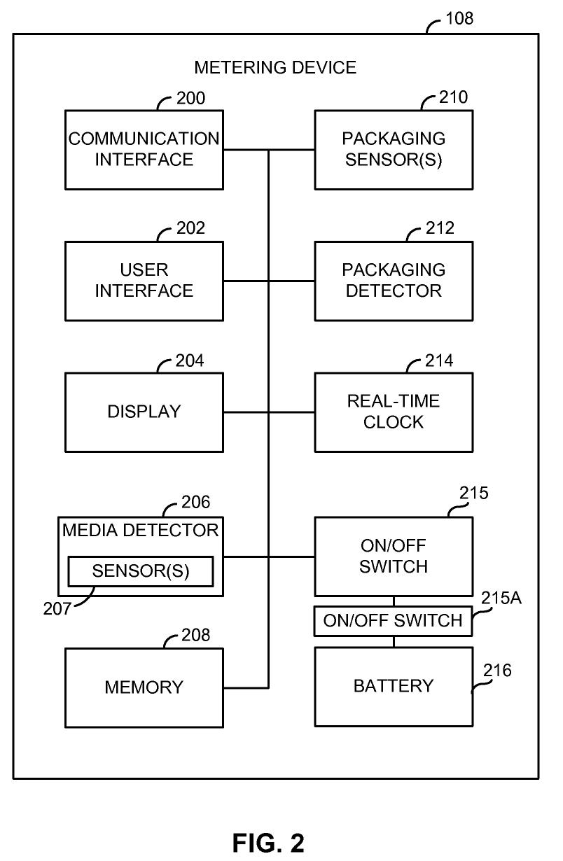

FIG. 2 is a block diagram of an example apparatus that may be used to implement the example metering device 108 of FIG. 1. In the illustrated example of FIG. 2, the example metering device 108 includes a communication interface 200, a user interface 202, a display 204, a media detector 206, a memory 208, a packaging sensor(s) 210, a packaging detector 212, a real-time clock 214, and a power supply, such as for example a battery 216. While an example manner of implementing the metering device 108 of FIG. 1 has been illustrated in FIG. 2, one or more of the elements, processes and/or devices illustrated in FIG. 2 may be combined, divided, re-arranged, omitted, eliminated and/or implemented in any other way. Further, each of the example communication interface 200, the user interface 202, the example display 204, the example media detector 206, the example memory 208, the example packaging sensor(s) 210, the example packaging detector 212, the example real-time clock 214, and/or, more generally, the example metering device 108 may be implemented by hardware, software, firmware and/or any combination of hardware, software and/or firmware. Thus, for example, any of the example communication interface 200, the user interface 202, the example display 204, the example media detector 206, the example memory 208, the example packaging sensor(s) 210, the example packaging detector 212, the example real-time clock 214, and/or, more generally, the metering devices 108 may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example communication interface 200, the user interface 202, the example display 204, the example media detector 206, the example memory 208, the example packaging sensor(s) 210, the example packaging detector 212, the example real-time clock 214, and/or, more generally, the example metering device 108 are hereby expressly defined to include a tangible, computer-readable medium such as a memory, DVD, CD, etc. storing the software and/or firmware. Further still, the example metering device 108 may include one or more elements, processes and/or devices in addition to, or instead of, those illustrated in FIG. 2, and/or may include more than one of any or all of the illustrated elements, processes and devices.

The communication interface 200 of the illustrated example enables the metering device 108 to convey and/or receive data to and/or from the other components of the media exposure measurement system 106. For example, the example communication interface 200 enables communication between the metering device 108 and the meter collection facility and/or central facility 114 after the metering device 108 is delivered to the meter collection facility and/or central facility 114. The communication interface 200 of FIG. 2 is implemented by, for example, an Ethernet card, a digital subscriber line, a coaxial cable, and/or any other wired and/or wireless connection.

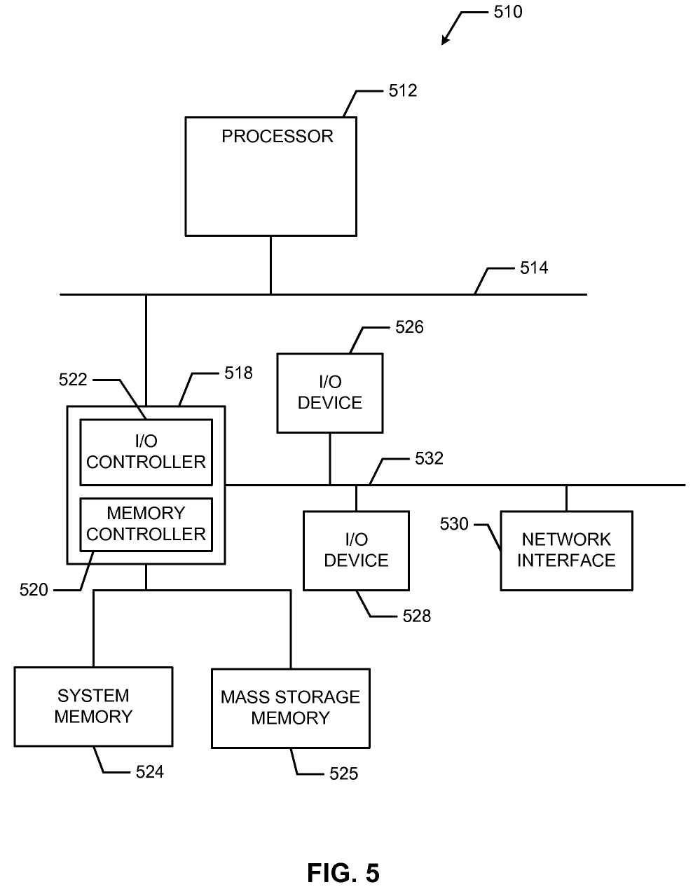

The user interface 202 of the illustrated example may be used by the panelist 122 or other user to enter data, such as, for example, identity information associated with the panelist 122 or other subject and/or demographic data such as age, race, sex, household income, etc. and/or commands into the metering device 108. Entered data and/or commands are stored, for example, in the memory 208 (e.g., memory 524 and/or memory 525 of the example processor system 510 of FIG. 5) and may be subsequently transferred to the central facility 114. The example user interface 202 is implemented by, for example, button(s), a keyboard, a mouse, a track pad, a track ball, a voice recognition system, and/or any other suitable interface.

The example display 204 of FIG. 2 is implemented using, for example, a light emitting diode (LED) display, a liquid crystal display (LCD), and/or any other suitable display configured to present visual information. In some examples, the display 204 conveys information associated with status information, such as, for example, whether the metering device is powered on or powered off, and/or mailing reminders. The example display 204, however, may be configured to display any desired visual information. Although the display 204 and the user interface 202 are shown as separate components in the example of FIG. 2, the display 204 and the user interface 202 may instead be integrated into a single component such as, for example, a touch-sensitive screen configured to enable interaction between the panelist 122 and the metering device 108.

The example media detector 206 of FIG. 2 includes one or more sensors 207, such as, for instance an optical and/or audio sensor configured to detect particular aspects of media to which the metering device 108 is exposed. For example, the media detector 206 may be capable of collecting signatures and/or detecting codes (e.g., watermarks) associated with media content to which it is exposed from audio signals emitted by an information presentation device. Data gathered by the media detector 206 is stored in the memory 208 and later used (e.g., at the central facility) to identify the media to which the metering device 108 is being exposed. The precise methods to collect media identifying information are irrelevant, as any methodology to collect audience measurement data may be employed without departing from the scope or spirit of this disclosure.

The example packaging sensor(s) 210 of FIG. 2 collect information to enable the determination of whether the metering device 108 is within a package 125 (i.e., to determine “packaging status”). For instance, in some examples described in detail below, the packaging sensor(s) 210 detect the light level in the environment surrounding the metering device 108, detect the distance between the metering device and objects surrounding the metering device 108 (e.g., light reflection, radio signal reflection, acoustical measurements, etc), detect the volume of air surrounding the metering device 108 (e.g., light reflection, radio signal reflection, acoustical measurements, multiple distance sensors, etc), and/or detect any RF field disturbances surrounding the metering device 108.

In the illustrated example, the packaging sensor(s) 210 are periodically or non-periodically activated to take a desired reading. For example, the packaging sensor(s) 210 may actively collect data at 30 minute intervals. The period of time between readings may be different for different applications. Additionally or alternatively, the sensor(s) 210 may continuously detect the state of environmental factors surrounding the metering device 108 (e.g., in the case of the sensor being a light sensor and the environmental factor being a light level.).

The data from the packaging sensor(s) 210 is conveyed to the packaging detector 212 which recognizes the detected environmental data and/or the state of the sensor(s) to determine whether the metering device 108 is within the package 125. In the case of a light sensor and/or suitable sensor and/or switch that is forced to the off state (e.g., an open circuit) by the occurrence of a predetermined environmental condition (e.g., a low light level), the detector 212 can be eliminated because the switch (which may be located to break a power supply current) effectively serves this function. Example implementations of the determination process are described in further detail below.

When the packaging detector 212 determines that the metering device 108 is housed within a package 125, the packaging detector 212 causes the metering device 108 to power off and/or continues to hold the device in the powered off state. Again, in the example where a light and/or suitable sensor (e.g., an environmental condition sensor) serves the detector function, the detector 212 may be omitted. While in some instances, the power off command may completely shut down power to all elements of the metering device 108, in this example, a power off command includes a powering down of all elements except for the example real-time clock 214 and the memory 208. In other words, when the metering device 108 is powered down, an electrical connection is maintained between the memory 208 and the battery 216 to enable the storage of information in the memory 208.

If the example packaging detector 212 determines that the metering device 108 is not located within a package 125, the metering device 108 may be powered on if necessary. For instance, when the metering device 108 is received by the panelist 122 and removed from the package 125, the packaging detector 210 may determine that the metering device 108 is not within a package 125 and may power on the metering device, and prepare the metering device 108 for recording data. In other examples, the metering device 108 is powered on at a predetermined time (i.e., a “wake-up” time) stored in the real-time clock 214 and/or stored in the memory 208 and based on a comparison to the time of the real-time clock 214. In still other examples, the metering device 108 may be continuously on unless the on/off switch 215 is actuated to off by a detected environmental factor (e.g., a low light level). Still further, the metering device 108 may include a switch 215A that may be depressed, moved, or otherwise activated by the panelist 122 or other user to power on the device 108. The inclusion of the packaging sensor(s) 210 and the packaging detector 212 ensures the device is off when shipped even if the panelist or manufacturer fails to turn off the device by activating the switch 215A prior to shipping.

The elements of the metering device 108 that receive power during either power off or power on modes may be chosen as desired. For example, during the power off mode the battery 216 may supply power to any desired subset of the example communication interface 200, user interface 202, display 204, media detector 206, memory 208, packaging sensor(s) 210, packaging detector 212, real-time clock 216, and/or any other element. However, the subset is preferably selected to comply with applicable shipping regulations. Power may be supplied in this subset by a circuit bypassing the switch 215. The bypass circuit (not shown) may also bypass the manual on/off switch 215A if desired.

The packaging sensor(s) 210 of the illustrated example are implemented using, for example, light switch(es), distance sensor(s), volume sensor(s), RF field disturbance sensor(s), and/or any other combination or type of sensor capable of detecting the environment surrounding the metering device 108 to determine whether the metering device 108 is within the package 125. When two or more on/off switches (e.g., light switches) are employed, they may be connected in series such that activation of any one of the switches is sufficient to power off the metering device or connected in parallel so that all switches must be activated to power off the device.

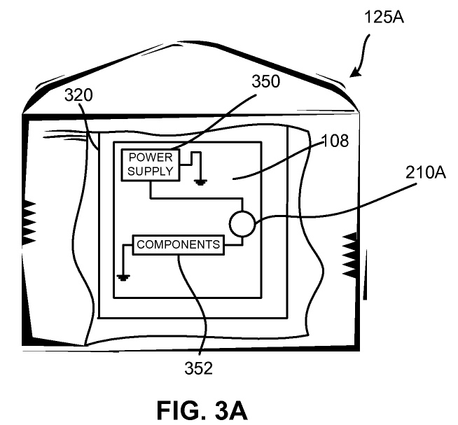

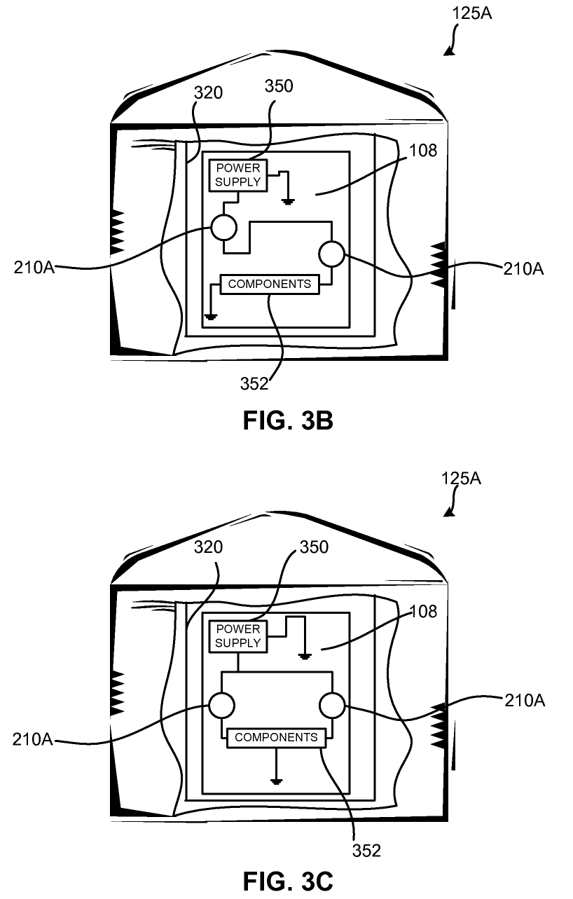

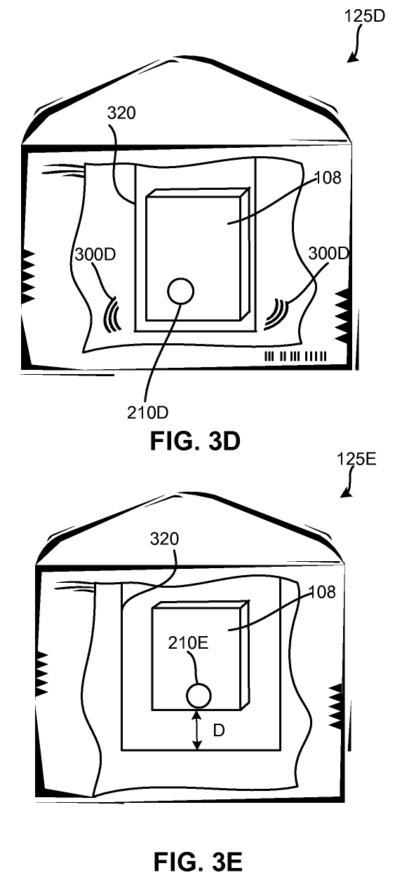

FIGS. 3A-3C illustrate example implementations of the example metering device 108 of FIG. 2 located within an example package 125A. In the illustrated examples of FIGS. 3A-3C the packaging sensor 210 is implemented by at least one light switch 210A, such as, for example, a light sensitive switch and/or any other switch capable of detecting an ambient light level surrounding the metering device 108. In some examples, the switch 210A may include a separate and/or integral high gain amplifier (not shown) so that even a small amount of light (e.g., in a low lit room) will be detectable. In the illustrated examples, when the metering device 108 is inserted into the package 125A, a low light or “dark” level changes the state of at least one of the switch(es) 210A (e.g., from “closed” to “open” or vice versa). The metering device 108 may include any number of switch(es) 210A to ensure a light level reading irrespective of the orientation of the device 108 within the package 125A.

The switch(es) 210A of the illustrated examples in FIGS. 3A-3C are capable of detecting the ambient light surrounding the metering device 108 to determine whether the metering device 108 is within the package 125A. In the example of FIG. 3A, a single light switch 210A is connected to a power supply 350 (e.g., the battery 216) such that a low light level reading by the switch 210A is sufficient to power off the components 352 (e.g., the communication interface 200, the user interface 202, the display 204, the media detector 206, etc.) of the metering device 108. The package 125D may include an internal housing such as, for example, a slot 320 or other suitable partition and/or container defined by the package 125D and sized to hold the metering device 108 when inserted into the package 125D. The slot 320 may be constructed of a dark and/or opaque material (e.g. a black wall) so that light cannot easily penetrate the walls of the slot 320.

When two or more on/off light switches 210A are employed, such as the examples illustrated in FIGS. 3B and 3C, the light switches 210A may be connected in series (FIG. 3B) such that a low light level detection by any one of the light switches 210A is sufficient to power off the metering device 108. Alternatively the switches 210A may be connected in parallel (FIG. 3C) so that all light switches 210A must detect a low light level condition to power off the metering device 108.

FIG. 3D illustrates another example implementation of the example metering device 108 of FIG. 2 located within an example package 125D. In the illustrated example, the packaging sensor 210 is implemented by at least one radio frequency field disturbance sensor 210D adapted to detect a disturbance in a radio frequency field 300D surrounding the metering device 108. For example, the radio frequency field disturbance sensor 210D may be a device which establishes the radio frequency field 300D in its vicinity and detects changes in that field resulting from the movement of objects (e.g., the inside walls of the package 125D) within the radio frequency field 300D. In the illustrated example, a single radio frequency field disturbance sensor 210A is shown. However, any number of sensors 310A may be utilized and located at one or more locations on the metering device 108 to ensure that the generated RF field 300D is detected by the sensor 210D regardless of the orientation of the example metering device 108 within the package 125D. The package 125D may include an internal housing such as, for example, a slot 320 or other suitable partition and/or container defined by the package 125D and sized to hold the metering device 108 when inserted into the package 125D. The walls of the slot 300 may be constructed of a material capable of disturbing the RF field 300D in a detectable manner. For example, the walls of the slot 320 may include a coating to reflect the RF field 300D back to the sensor 210D such that the field 300D is intensified. Additionally or alternatively, the package 125D may be constructed of paper, cardboard, plastic, and/or any other suitable packaging material capable of causing a disturbance in the generated RF field 300D. In some examples, the package 125D includes shielding (not shown) to prevent the generated RF field 300D from traveling outside of the package 125D. Such shielding may help to prevent false triggering of the radio frequency field disturbance sensor 210D when, for example, the metering device is located near, but outside, the package 125D.

When the metering device 108 is inserted into the package 125D, disturbances in the generated RF field 300D caused by the packaging environment (e.g. the inner walls of the package 125D or the slot 320) are detected by the radio frequency field disturbance sensor 210D. In other words, when the metering device 108 is inserted into the package 125D the interior of the package 125D will cause a disturbance in the generated RF field 300D which is detectable by the radio frequency field disturbance sensor 210D. Because the radio frequency field disturbance sensor 210D is capable of detecting disturbances in the RF field 300D on any side of the metering device 108, the orientation of the metering device 108 within the package 125D is irrelevant, as the radio frequency field disturbance sensor 210D will cause disturbances in any orientation.

FIG. 3E illustrates another example implementation of the example metering device 108 of FIG. 2 located within an example package 125E. In the illustrated example of FIG. 3E, the packaging sensor 210 is implemented by volume and/or distance sensor 210E. The sensor 210E is capable of detecting a distance D between the metering device 108 and a surrounding object, such as, for example, an interior surface of the package 125E. The sensor 210E may detect the distance D by, for example, light reflection, radio signal reflection, acoustical measurements, etc. Additionally or alternatively, the sensor 210E is capable of detecting the amount of free space (e.g., volume of air) surrounding the metering device 108. In some examples, a plurality of sensors 210E may be distributed along multiple side of the metering device 108 to calculate the volume of space surrounding the metering device by a simple geometric volume calculation utilizing multiple distance readings (e.g., length times width times height (V=l×w×h)). By utilizing a total volume calculation, false positives may be prevented and/or reduced when, for example, the metering device 108 is placed close to an object (e.g. a piece of furniture) within a line of sight of the sensor 210E, but not within the package 125E.

The example package 125E may also include an internal housing such as, for example, a slot 320 defined by the package 125E and sized to hold the metering device 108 when inserted into the package 125E in any desired orientation, and with a desired spacing between the metering device 108 and the walls of the slot 320. By creating a desired spacing between the metering device 108 and the walls of the slot 320, the number of false triggering events may be reduced as the distance D may be compared to a known range based upon the desired spacing.

When the metering device 108 is inserted into the package 125E, the inside wall of the package 125E and/or a wall of the slot 320 is detected by the distance sensor 210E. In other words, when the metering device 108 is inserted into the package 125E and brought into proximity to the inside wall of the package 125E, the distance D between the wall and the metering device 108 is detected by the distance sensor 210D. The metering device 108 enters a powered down state when the distance and/or when the volume of space surrounding the metering device 108 (either detected or calculated) is less than a threshold. Alternatively, the metering device 108 may enter the powered down state when the distance D, and/or volume is within a range of volumes.

As described above in connection with FIG. 2, the packaging sensor(s) 210 (e.g., the light switch 210A, the radio field disturbance sensor 210D, and/or the distance and/or volume sensor 210E) detects the state of a particular factor of the environment surrounding the metering device 108, generates a signal indicative of the detected factor, and conveys the signal to the packaging detector 212 (if present). In examples that employ a packaging detector 212, the packaging detector 212 compares the received signal to a criterion or expected value, such as, for example, a threshold or other value to determine whether the metering device 108 is within the package 125. In simplified examples, no comparison is performed and any signal detected by the sensor(s) causes a power down event. In examples employing a light switch, the change in state of the switch (e.g., low light) may cut the power without any further processing. As described above, if the packaging detector 212 (where employed) determines that the metering device 108 is within the package 125, the metering device 108 will be powered down.

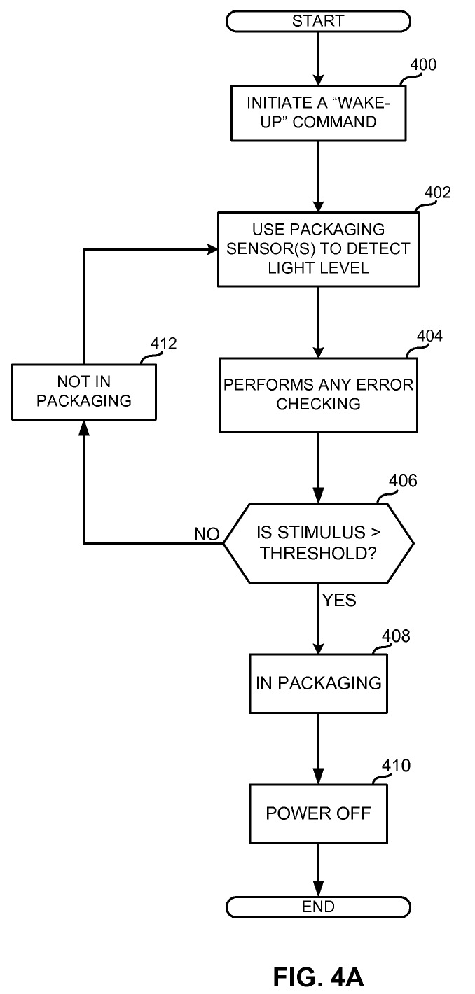

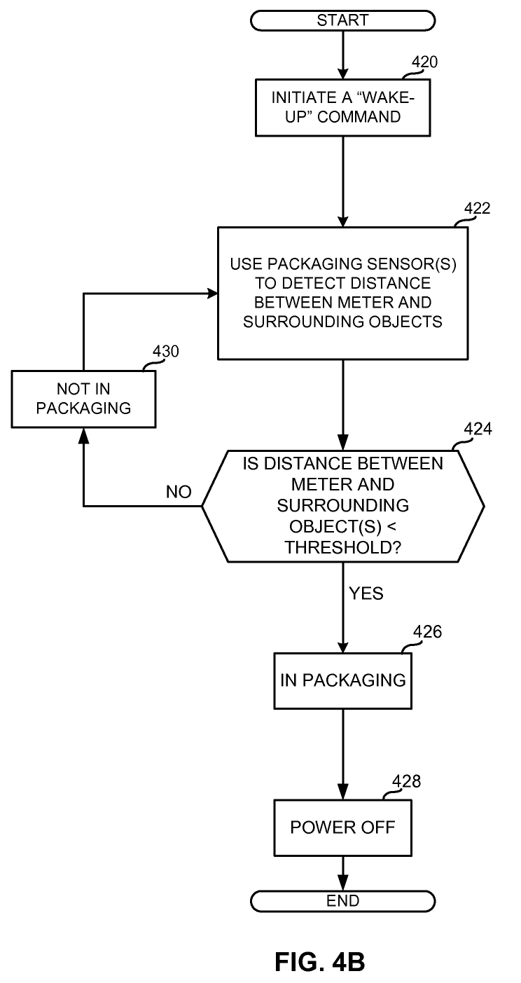

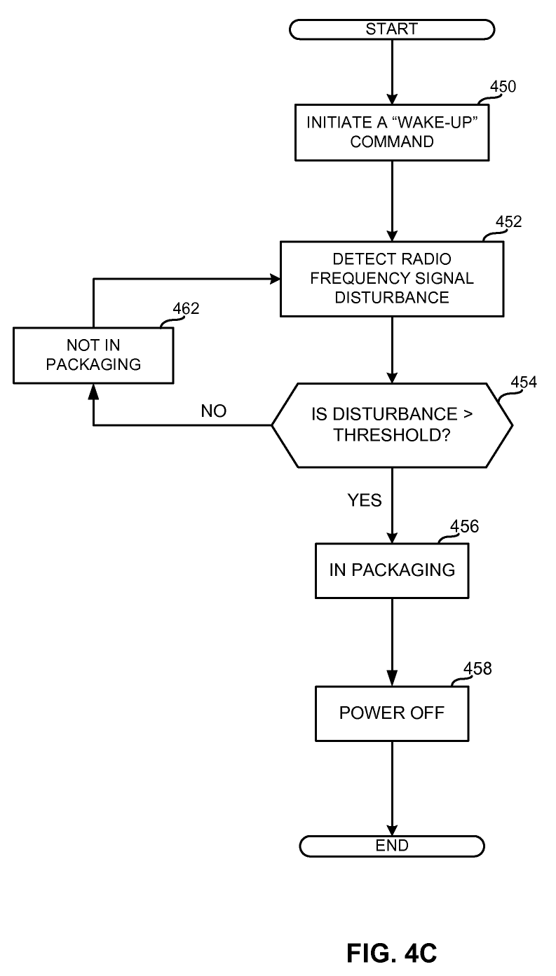

The flow diagrams of FIGS. 4A-4C are representative of machine readable instructions that can be executed on a particular machine to implement the example methods, apparatus, systems, and/or articles of manufacture described herein. In particular, FIGS. 4A-4C depict flow diagrams representative of machine readable instructions that may be executed to implement the example metering device 108 of FIGS. 1, 2, and/or 3A-3C to detect an environmental condition, to determine whether the metering device 108 is in the package 125, and to power off the metering device 108 when it is determined that the device is packaged. The example instructions of FIGS. 4A-4C may be performed using a processor, a controller and/or any other suitable processing device. For example, the example instructions of FIGS. 4A-4C may be implemented in coded instructions stored on a tangible medium such as a flash memory, a read-only memory (ROM) and/or random-access memory (RAM) associated with a processor (e.g., the example processor 512 discussed below in connection with FIG. 5). Alternatively, some or all of the example instructions of FIGS. 4A-4C may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example instructions of FIG. 4 may be implemented manually or as any combination(s) of any of the foregoing techniques, for example, any combination of firmware, software, discrete logic and/or hardware. Further, although the example instructions of FIGS. 4A-4C are described with reference to the flow diagram of FIGS. 4A-4C, other methods of implementing the instructions of FIGS. 4A-4C may be employed. For example, the order of execution of the blocks may be changed, and/or some of the blocks described may be changed, eliminated, sub-divided, or combined. Additionally, any or all of the example instructions of FIGS. 4A-4C may be performed sequentially and/or in parallel by, for example, separate processing threads, processors, devices, discrete logic, circuits, etc.

In the examples of FIGS. 4A-4C, the methodology for collecting the media exposure data is not shown. However, it will be understood that media exposure data is being substantially constantly collected (if available) and time stamped when the device is powered on. Thus, the exposure data may be collected in parallel with the execution of the instructions of FIGS. 4A-4C. Thus, for example, the media exposure data may be collected using any desired technique by a parallel thread or the like.

Turning to FIG. 4A, the metering device 108 detects the amount of light that is present in the environment surrounding the metering device 108 to determine whether the metering device 108 is within a package. For example, as illustrated in FIG. 4A, the metering device 108 initiates a “wake-up” command to power on the device 108 if necessary (block 400). For example, the metering device 108 may be powered on at a predetermined time (e.g., a “wake-up” time) stored in the real-time clock 214 and/or stored in the memory 208 and based on a comparison of the predetermined time to the time of the real-time clock 214. The “wake-up” command may be initialized upon activation of the device 108 (e.g., upon completion of manufacturing) and therefore, in some examples, the device 108 may be considered always awake(e.g. powered down by the switch 215A during shipping). Once powered on, the packaging sensor(s) 210 detects a level of ambient light, such as, for example, the amount of light surrounding the metering device 108 (block 402). As described above, the packaging sensor(s) 210 may be implemented by at least one light switch. When two or more on/off light switches are employed, they may be connected in series such that activation (e.g., switching off) of any one of the light switches is sufficient to power off the metering device or connected in parallel so that all light switches must be activated (e.g., switched off) to power off the device. Additionally, when employed, the packaging detector(s) 212 may perform an error check (e.g., a check for a false positive) as desired (block 404). For example, the packaging detector(s) 212 may employ a high gain amplifier such that a low amount of ambient light (e.g. a low lit room) will not activate (e.g., switch off) the light switch. Additionally or alternatively, the packaging detector(s) 210 may initiate a timer and the device 108 may only power off if the low light condition persists for a sufficient time period to ensure that the packaging sensor(s) 210 switch was not just temporarily placed in a dark environment. Additional or alternative error checks may be provided.

Once the light level is detected, the packaging detector(s) 212, if employed, compares the detected light level to a threshold to determine the meter's packaging status (block 406). A positive determination that the metering device 108 is located within the package 125 (block 408), results in an initiation of a powering off of the metering device 108 (block 410). Otherwise, the metering device 108 is not located within the packaging 125 (block 412) and control advances to block 402 to detect another light level (block 402). As noted above, the package detector functionality may be integrated into the packaging sensor(s) 210 (e.g., a low light level automatically activates the switching capabilities of the light sensor), and the package detector(s) 212 may be eliminated.

In the example of FIG. 4B, the metering device 108 initiates a “wake-up” command to power on the device 108 if necessary (block 420). Once powered on, the packaging sensor(s) 210 collect input(s) reflecting the distance between the metering device 108 and one or more surfaces proximate the metering device 108 (block 422). In the illustrated examples, the space in the surrounding environment is calculated based on the distance(s) measured by the packaging sensor(s) 210 (e.g., the distance sensor(s) 210F and/or a volume sensor(s)). As described above, the packaging sensor(s) 210 may be a single distance sensor or a plurality of distance sensors whose outputs are used to calculate at least one of a space or volume surrounding the metering device 108. The characteristics of the received environment may be used to determine the location of the metering device 108 relative to the package 125.

In particular, the detected distance D and/or volume is compared to a stored value, range, or criterion, such as a threshold, to determine whether the metering device 108 is located within the package 125 (block 424). As noted above, the stored value, criterion, or threshold, may be determined by any suitable method, including, for instance, previous sampling, statistical analysis of multiple samples, previous readings, information stored in the memory 208, and/or any other determination/storage method. For example, if the detected environmental factor is a distance reading between the metering device 108 and the nearest surface in front of the meter, the packaging detectors(s) 212 compares the distance from the sensor 210 to a threshold (block 424). If the detected distance is less than the threshold (e.g., minimum distance requirement) (block 424), the packaging detector(s) 212 determines that the metering device 108 is located within the packaging 125 (block 426).

If the packaging detector(s) 212 determines that the metering device 108 is located within the package 125, the packaging detector(s) 212 powers off of the metering device 108 (block 428). As described above, while in some instances, the power off mode may completely shut down power to all elements of the metering device 108, in this example, a power off mode includes a powering down of all elements except for the example real-time clock 214 and the memory 208.

If, however, the detected distance is not greater than the threshold (e.g., minimum distance requirement) (block 424), the packaging detector(s) 212 determines that the metering device 108 is not located within the packaging 125 (block 430). Control advances to block 422 to await the detection of the next environmental reading (block 422).

In still other examples, such as the example illustrated in FIG. 4C, the packaging detector(s) 212 identify a radio frequency disturbance field within the environment surrounding the metering device 1081. In particular, referring to FIG. 4C, the metering device 108 initiates a “wake-up” command to power on the device 108 if necessary (block 450). Once powered on, the packaging sensor 210 collects an input reflecting the disturbance (if any) of a radio frequency signal generated by the packaging sensor 210 or any other suitable device (e.g., the RF disturbance field sensor 210E) (block 452). The packaging detector(s) 212 identify the disturbance and compare the identified disturbance to a known criterion or threshold indicative of an “in package” condition (block 454). If the disturbance signal is greater than the threshold (e.g., a known disturbance threshold stored in the memory 208) (block 454), the packaging detector(s) 212 determine that the metering device 108 is located within the packaging 125 (block 456).

If the packaging detector(s) 212 determine that the metering device 108 is located within the package 125, the packaging detector(s) 212 initiate a powering off of the metering device 108 (block 458). If however, the disturbance signal is not greater than the disturbance threshold (block 454), the packaging detector(s) 212 determines that the metering device 108 is not located within the packaging 125 (block 460). Control then advances to block 452 to await the detection of the next environmental reading (block 452).

FIG. 5 is a block diagram of an example processor system 510 that may be used to execute the instructions of any of FIGS. 4A-4C to implement the example metering device 108 of FIG. 2. As shown in FIG. 5, the processor system 510 includes a processor 512 that is coupled to an interconnection bus 514. The processor 512 may be any suitable processor, processing unit or microprocessor. Although not shown in FIG. 5, the system 510 may be a multi-processor system and, thus, may include one or more additional processors that are different, identical or similar to the processor 512 and that are communicatively coupled to the interconnection bus 514.

The processor 512 of FIG. 5 is coupled to a chipset 518, which includes a memory controller 520 and an input/output (I/O) controller 522. The chipset 518 provides I/O and memory management functions as well as a plurality of general purpose and/or special purpose registers, timers, etc. that are accessible or used by one or more processors coupled to the chipset 518. The memory controller 520 performs functions that enable the processor 512 (or processors if there are multiple processors) to access a system memory 524 and a mass storage memory 525.

The system memory 524 may include any desired type of volatile and/or non-volatile memory such as, for example, static random access memory (SRAM), dynamic random access memory (DRAM), flash memory, read-only memory (ROM), etc. The mass storage memory 525 may include any desired type of mass storage device including hard disk drives, optical drives, tape storage devices, etc.

The I/O controller 522 performs functions that enable the processor 512 to communicate with peripheral input/output (I/O) devices 526 and 528 and a network interface 530 via an I/O bus 532. The I/O devices 526 and 528 may be any desired type of I/O device such as, for example, a keyboard, a video display or monitor, a mouse, etc. The network interface 530 may be, for example, an Ethernet device, an asynchronous transfer mode (ATM) device, an 802.11 device, a DSL modem, a cable modem, a cellular modem, etc. that enables the processor system 510 to communicate with another processor system.

While the memory controller 520 and the I/O controller 522 are depicted in FIG. 5 as separate blocks within the chipset 518, the functions performed by these blocks may be integrated within a single semiconductor circuit or may be implemented using two or more separate integrated circuits.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. An audience measurement device, comprising:
a housing;
a media detector in the housing to collect media exposure data;
a packaging sensor to detect an environmental condition exterior to the housing;
a packaging detector to compare the detected environmental condition to a criterion to determine whether the device is located within a package.

2. A device as defined in claim 1, wherein the packaging detector causes the device to at least partially power down when the packaging detector determines that the device is located within the package.

3. A device as defined in claim 1, further comprising a memory to store the collected media exposure data.

4. A device as defined in claim 2, wherein the packaging detector maintains a supply of power to a clock when the packaging detector determines that the device is located within the package.

5. A device as defined in claim 1, wherein the package is a mailer.

6. A device as defined in claim 1, wherein the media exposure data comprises at least one of a signature or a code to which the device is exposed.

7. A device as defined in claim 1, further comprising a real-time clock.

8. A device as defined in claim 7, further comprising a user interface to communicate information to a user, the user interface to display a message to the user based upon the real-time clock.

9. A device as defined in claim 1, wherein the environmental condition is at least one of a light level, a radio-frequency disturbance, a distance between the housing and an object exterior to the housing, or a volume of free space adjacent the housing.

10. An audience measurement device, comprising:
a housing;
a media detector in the housing to collect media exposure data; and
a light sensor to detect light in the environment adjacent the housing, the light sensor to cause the media detector to at least partially power down when the light sensor detects less than a threshold amount of light.

11. A device as defined in claim 10, further comprising a packaging detector to compare the detected light to a threshold to determine when the device is located within a package.

12. A device as defined in claim 11, further comprising a memory to store the collected media exposure data.

13. A device as defined in claim 11, further comprising a real-time clock.

14. A device as defined in claim 13, further comprising a user interface to communicate information to a user, the user interface to display a message to the user based upon a time indicated by the real-time clock.

15. A method of enforcing a power down state in an audience measurement device during shipping of the device, comprising:
detecting an environmental condition exterior to the audience measurement device;
comparing the detected environmental condition to a criterion to determine whether the device is located within a container; and
powering off at least a portion of the audience measurement device if the device is located within the container.

16. A method as defined in claim 15, wherein the environmental condition is a light level and the criterion is a threshold.

17. A method as defined in claim 15, wherein the environmental condition is at least one of a light level, a radio-frequency disturbance, a distance between the housing and an object exterior to the housing, or a volume of free space adjacent the housing.

18. A method as defined in claim 15, further comprising powering on the audience measurement device if the device is not located within the container.

19. A method as defined in claim 15, further comprising collecting media exposure data with the audience measurement device.

20. A machine readable medium having instructions stored thereon that, when executed by a processor, cause a machine to:
detect an environmental condition exterior to an audience measurement device;
compare the detected environmental condition to a criterion to determine whether the device is located within a container; and
power off at least a portion of the audience measurement device if the device is located within the container.
